(19) United States
(12) Patent Application Publication
(10) Pub. No.: US 2014/0208969 A1
(43) Pub. Date: Jul. 31, 2014

(54) METHOD FOR PRODUCING A PRINTING PLATE FOR WATERLESS OFFSET PRINTING

(71) Applicant: Gert Sieger, Stuttgart (DE)

(72) Inventor: Gert Sieger, Stuttgart (DE)

(21) Appl. No.: 14/239,975

(22) PCT Filed: Aug. 23, 2012
(86) PCT No.: PCT/EP2012/066433

§ 371 Date: Feb. 20, 2014

(30) Foreign Application Priority Data
Aug. 25, 2011 (DE) 10 2011 052 991.8

(51) Int. Cl. B41C 1/00; B41N 1/00

(52) U.S. Cl. CPC B41C 1/003; B41N 1/00
USPC 101/395; 427/256; 427/535; 427/558

(57) ABSTRACT

The invention relates to a method for producing a printing plate for waterless offset printing. A method for producing a printing plate for waterless offset printing is proposed, having the following method steps:-providing a substrate;-applying an ink onto the substrate using an inkjet printing technique; and-fixing the applied ink on the substrate. The method is characterized in that the substrate has a surface tension of >35 mN/m, preferably >38 mN/m, and the ink has a surface tension of <30 mN/m, preferably <25 mN/m, when fixed on the substrate. The ink is applied into substrate regions which should not have printing ink during the offset printing process.

### CROSS-REFERENCE TO RELATED APPLICATIONS

This application is a National Stage of International Application No. PCT/EP2012/066433, filed on Aug. 23, 2012, and published in German as WO 2013/026904 A1 on Feb. 28, 2013. This application claims the benefit and priority of German Application No. 10 2011 052 991.8, filed on Aug. 25, 2011. The entire disclosures of the above applications are incorporated herein by reference.

### BACKGROUND

The present invention relates to a method for producing a printing plate for waterless offset printing.

### TECHNICAL FIELD

Offset printing is an indirect planographic printing process, which since the beginning of the 20^{th} Century has been widely used in various fields. In addition to the use in the field of book and newspaper printing offset printing is in particular being applied to the field of commercial printing and printing of packing materials of different types. Herein, the basic principle of offset printing is based on developments in lithography as have already been used since the end of the 18th century.

### DISCUSSION

In the traditional wet offset printing process printing plates are usually produced in several mostly photochemical steps, wherein the surfaces of the printing plates are separated into hydrophilic and hydrophobic regions. In the offset printing machine water or an aqueous mixture of different adjuvants such as isopropanol is applied to the thus produced printing plates by means of a roller, the so-called dampener. The hydrophilic regions of the printing plate retain the water and the aqueous mixture, respectively, while the hydrophobic regions remain dry. By means of an ink roller, the so-called inking unit, a fatty printing ink is applied to the watered printing plate, which is repelled by the water-wetted hydrophilic regions and adheres at the dry hydrophobic regions. The thus inked printing plate is unrolled onto a rubber blanket, which then transfers the printed image onto the medium to be printed. It is therefore an indirect printing process in which the printed image is not transferred directly from the printing plate onto the medium to be printed.

One disadvantage of wet offset printing process is that both in the production of the printing plate and in the printing process itself by means of the dampening solution a variety of adjuvants are used, which one would like to avoid environmentally.

One approach to avoid these adjuvants is waterless offset or dry offset. Here, as printing plates silicone coated printing plates in combination with silicone-based printing inks are used. The silicone coated printing plate is lipophobic and repels the printing ink. The printed image is applied onto the printing plate by means of, for example, laser irradiation by removing the silicone coating from the printing ink-carrying regions of the printing plate. A decomposition of the printing ink into the color components on the one hand and silicone oil on the other hand occurs on the printing plate, wherein the color components will adhere on the regions which are different from the silicone-free regions of the printing plate.

European patent application EP 0672950 A1 discloses a corresponding printing plate for waterless offset printing, which can be structured appropriately by laser irradiation. To this end, a photosensitive layer is applied between a silicone coating and a substrate, which results in the separation of the silicone coating in the irradiated regions by laser irradiation of a suitable wavelength. The thus exposed regions are lipophilic so that the printing ink in these regions continues to adhere at the printing plate.

U.S. Pat. No. 4,003,312 discloses a method for producing a print template by means of an ink jet technique. A master is provided by depositing a silicone onto a suitable master substrate by means of an ink jet printing apparatus and curing the silicone into an elastomeric state. Alternatively, an ink jet printing apparatus may be used to apply a catalyst onto an uncured silicone on a master substrate such that the silicone is caused to cure in the regions treated with the catalyst.

DE 19500486 A1 discloses a photosensitive lithographic printing plate requiring no wetting water. The printing plate comprises an aluminum substrate on which a primer layer, a photosensitive layer and a silicone rubber layer are applied, wherein the aluminum surface has an average roughness Rₐ of 0.2 to 0,8 μm and a degree of whiteness from 0.10 to 0.35.

EP 1046497 A1 discloses a method for producing a lithographic printing plate comprising the step of distributing a novolak resin in a predetermined pattern on a hydrophilic surface of a lithographic base.

US 2006/0188813 A1 discloses a hydrophilic film on a print template, which is available by curing a composition by heat or light, which comprises at least two five- or six-membered hydrophilic ring structures. The compound can be applied onto the surface by means of an ink jet technique.

The waterless offset process offers the advantage that an emission of the dampening solution, as occurs in wet offset printing, is avoided. In addition it is possible to produce finer screens on the medium to be printed. Typically a low start-up waste (for example, 20 sheets instead of 200) is obtained, since the printing plate does not have to be dampened. Moreover, a more accurate printout of the screen dots, a better fine detail reproduction and a reduced tonal value increase are achieved. In printing machine itself a dampening system can be dispensed with, such that the design work significantly decreases. This also reduces the maintenance effort of the printing machines. By eliminating dampening solutions, moreover, corrosion of metal inks can be avoided, thereby increasing the color fastness of the printout.

However, a disadvantage of the waterless offset printing technique is that the printing plates are more expensive than in the wet offset process. Also the used printing plates are scratch-sensitive and only difficult to correct after their development (exposure). With ink jet techniques hitherto used for the production of printing plates no sufficient resolutions for the production of high-quality printouts can be obtained. Also the obtainable durability of the printing plates thus produced is clearly limited so that they can be used only for printing a very small number of copies.

### SUMMARY OF THE INVENTION

It is therefore an object of the present invention to provide a method for producing printing plates for waterless offset printing, by which it is possible to overcome the disadvantages known from the prior art and, in particular, to produce printing plates more cost effectively.

This object is achieved by a method according to the teachings of the present disclosure. Embodiments of the method can be found in the following description.

Thus, a process for producing a printing plate for waterless offset printing is proposed, comprising:
providing a substrate;
applying an ink onto the substrate by means of an ink jet technique;
fixing the applied ink on the substrate,

characterized in that the substrate has a surface tension of ≧35 mN/m, preferably ≧38 mN/m, and the ink has a surface tension of ≦30 mN/m, preferably ≦25 mN/m, in a state fixed on the substrate and said ink is applied in the regions of the substrate which should not carry any printing ink during the offset printing process.

By means of the method according to the invention it is advantageously possible to produce printing plates for waterless offset printing quickly and inexpensively. By use of an appropriate ink jet device, such as an ink jet printer, it is possible with the method according to the invention to produce masters in a data processing system and to transfer them directly to a printing platen to provide a printing plate.

According to the invention it is provided that the printing plate is made such that in the regions of the substrate, which as a printing plate in the printing process is not to carry printing ink, a coating is applied by means of an ink jet technique, which is sufficiently lipophobic to repel the printing ink, while the uncoated regions of the substrate are sufficiently lipophilic such that printing ink will adhere. Such, according to the invention a negative of the printed image is applied onto the substrate by coating the background of the printing plate which carries no printing ink.

Surprisingly it has been found that substrates having a surface tension of ≧35 mN/m are adapted to reliably carry printing inks, while inks having a surface tension of ≦30 mN/m in the fixed state, repel printing inks sufficiently reliable. Thus, it has surprisingly been found that a difference in the surface tension between the printing ink-carrying regions and the ink-repelling regions of the printing plate of ≧5 mN/m is sufficient to produce a printed image in waterless offset printing.

In one embodiment of the method according to the invention at least the surface of the substrate is made of a material selected from the group consisting of aluminum, aluminum alloys, steel, polycarbonate, polyester, and polyolefin. Herein, the surface means the region of the substrate which in the printing process comes into contact with the printing ink. According to the invention the substrate can be a composite structure which consists of a base support onto which a material of the group mentioned above has been applied. Thus, it may be provided, for example, that a polycarbonate layer is applied to a base support made of steel sheet. Preferably it is provided that the substrate is made of only one material.

In a further embodiment of the method according to the invention it can be provided that prior to applying the ink the substrate is pretreated in order to modify its surface roughness. Herein, in particular it is provided that the surface roughness Rₐ of the substrate is adjusted to value less than 1 μm. Herein, the roughness is determined in accordance with EN ISO 25178. By setting an appropriate roughness it is ensured that the ink in the fixed state has an adequate adhesion to the substrate in order to ensure a sufficient durability of the printing plate. Herein, a service life of ≧100,000 printed copies per printing plate is considered as a sufficient durability.

In setting an appropriate surface roughness and/or surface tension of the substrate according to one embodiment of the invention it may be provided that the substrate is pretreated by pickling, etching, corona treatment or plasma treatment.

In the method according to the present invention the ink can be applied onto the substrate by means of known ink jet techniques. Thus, it may be provided, for example, that the ink is applied by means of the CIJ method (continuous ink jet method) or the DOD method (drop on demand method). CIJ printers are known from the field of industrial printing. Here, the ink jet exits from a print head through a nozzle, wherein the jet is modulated by a piezoelectric transducer downstream of the nozzle in order to achieve a uniform ink drop breakup. The exiting droplets are electrostatically charged by an electrode and subsequently pass a deflection field built up by a further electrode within which they are deflected depending on their charge, wherein it is distinguished between a binary deflecting method and a multi deflecting method. Ink droplets not required for the pressure are collected and returned into the ink circuit.

On the contrary, in the DOD process only the ink drop actually to be applied as a printed image exits the nozzle. Herein a distinction is made among the different techniques by which the ink droplets are ejected. For bubble-jet printers the ink droplets needed are generated by use of a heating element, which heats the ink. Herein, a vapor bubble is formed explosively which presses an ink droplet out of the nozzle by means of its pressure. Herein, depending on the type of vapor bubble generation it is to be distinguished between sideshooter systems and edgeshooter systems. In piezo printers a piezoceramic element is deformed by applying an electric voltage in order to press printing ink through a nozzle by means of the deformation. Herein, the droplet size can be controlled by means of the applied electric pulse.

According to a preferred embodiment of the method according to the present invention the ink is applied onto the substrate with a dot density of ≧1200 dpi, preferably ≧2400 dpi.

After application onto the substrate the ink is fixed. This can be done by air drying. However, in an embodiment of the method according to the present invention it may also be provided that the ink after applying onto the substrate is fixed by means of UV radiation and/or thermal radiation. This advantageously allows a rapid fixing of the ink.

According to a further embodiment of the method according to the present invention it may be provided that the ink is a silicone, a polyisoprene and/or fluorine plastic, in particular a poly(dimethylsiloxane). Furthermore, the ink may comprise adjuvants such as solvents, agents for adjusting the surface tension in the fixed state, and/or fixing agents.

In a further embodiment of the method according to the present invention a UV curing ink is used as ink. Herein, it may be provided that the ink is a radically or cationically curing ink. In radically curing inks unsaturated resins are used with reactive groups which lead to a crosslinking reaction via free radicals. In general these are acrylated resins or monomers having terminal acrylic acid groups (acrylic acid esters). In addition to the acrylates other compounds with reactive double bonds, such as unsaturated polyester resins and vinylic monomers such as styrene, may be crosslinked via this mechanism. In the irradiation of UV light photoinitiators included within the ink spontaneously decompose into free radicals and trigger a chain reaction for the polymerization. This results in a three-dimensionally crosslinked, insoluble and solid structure of macromolecules. This is done within seconds or fractions of a second so that immediately after curing a stressable film is formed.

In cationically curing UV inks curing takes place according to a different reaction mechanism. Here a compound including an oxirane group serves as a resin base. As an initiator an acid is used which is activated only by exposure. Usually a cycloaliphatic epoxy resin serves as the resin component. The protons of the acid cause the epoxide ring to open and start a polymerization with continuing chain growth. The combination of epoxy resins with polyoles enables the adjustment of the film properties of the fixed ink according to the requirements of the invention in an advantageously way.

In order to exclude an interfering influence of oxygen it may be particularly preferable according to the present invention that the application of the ink onto the substrate is conducted under an inert gas atmosphere, for example under a nitrogen, carbon dioxide, helium or argon atmosphere. As a result detrimental oxidation reactions of the ink or of the substrate surface with atmospheric oxygen can be excluded, whereby on the one hand the adhesion of the ink with respect to the substrate is improved, which in turn increases the durability of the printing plate and the print run which can be achieved with said printing plate. On the other hand by reducing or suppressing the oxidation reactions induced by atmospheric oxygen a higher resolution can be achieved, because an oxidatively induced blurring of the edges of the pixels can be prevented.

An inert gas atmosphere in the sense of the present invention means that the oxygen concentration in the working atmosphere is ≦5 vol-%, preferably ≦1 vol-%, particularly preferably ≦0.5 vol-%.

In a further preferred embodiment of the invention it is provided that at least the ink application takes place in a low humidity atmosphere in order to avoid detrimental effects of any residual moisture. Low humidity means in accordance with the invention that the water content in the working atmosphere is ≦1 vol-%, preferably ≦0.5 vol-%, particularly preferred ≦0.1 vol-%.

In particular, it can be provided according to the invention that the ink is applied in a dry inert gas atmosphere having a residual moisture content of ≦0.1 vol-%.

Furthermore, according to the invention it can be provided that the above described optional setting of the surface roughness Rₐ of the substrate to less than 1 μm is carried out in an inert gas atmosphere, in particular in a dry inert gas atmosphere. Herein, it is particularly preferred that a moisture and/or oxygen contact of the substrate between the setting of the surface roughness and the application of the ink is avoided.

In the method according to the present invention in the ink applied to the substrate, for example, a silicone, particularly a poly(dimethylsiloxane), a polyisoprene, in particular a poly-2-methyl-1,3-butadiene, or mixtures thereof may be used as binders. In order to reduce the surface energy, for example, in the ink applied onto the substrate a silicone oil, a fluorine tenside, a fluorine plastic, in particular a perfluoroalkoxylalkane and/ or a perfluorooctane sulfonate, a silicone, in particular a poly(dimethylsiloxane), a polyisoprene, in particular, a poly-2-methyl-1,3-butadiene or mixtures thereof may be included. As a solvent in the ink applied onto the substrate, for example, a short-chained hydrocarbon, N-methyl-2-pyrrolidone, toluene or a mixture thereof may be included. As a dye in the ink applied onto the substrate, for example, a triphenylmethane, a (4-(4,4′-bis(dimethylaminophenyl)benzhydryliden) cyclohexa-2,5-dien-1-ylidene)dimethyl-ammonium chloride or a mixture thereof may be included.

According to a further embodiment of the invention a coloring agent is added to the ink. This makes it possible to supply the printing plate to an optical check after its production in order to detect any errors.

### BRIEF DESCRIPTION OF THE DRAWINGS

The drawings described herein are for illustrative purposes only of selected embodiments and not all possible implementations, and are not intended to limit the scope of the present disclosure.

The invention will hereinafter be described with respect to embodiments and figures without limiting the inventive idea to these examples.

FIG. 1 schematically illustrates a production method according to the invention;

FIG. 2 shows a printing plate produced according to the invention;

FIG. 3 shows a printing plate produced according to the invention comprising a printing ink applied thereto; and

FIG. 4 shows the printed image produced with a printing plate according to the invention.

Corresponding reference numerals indicate corresponding parts throughout the several views of the drawings.

### DETAILED DESCRIPTION OF THE PREFERRED EMBODIMENTS

Example embodiments will now be described more fully with reference to the accompanying drawings.

FIG. 1 schematically illustrates a production method according to the invention for producing a printing plate 100 for waterless offset printing. An ink 300 is applied to a substrate 200 by means of an ink jet device 400. The substrate 200 in this case according to the invention has a surface tension of ≧35 mN/m. As a material for the substrate 200, for example, aluminum, an aluminum alloy, steel, a polycarbonate, a polyester, or a polyolefin may be used. Likewise, it may be provided that the substrate 200 has a composite structure in which a coating is applied onto a base layer which has a surface tension in the range of the invention. For varying or adjusting the surface tension of the substrate 200 to the tension value provided according to the invention the substrate 200 may be subjected to an appropriate surface treatment before the ink 300 is applied to the latter. Examples of appropriate surface treatments are pickling, etching, corona treatment or plasma treatment. The ink droplets 310 are applied in the regions of the substrate 200 which in the subsequent offset printing process should not carry any printing ink. In order to avoid any reactions of the ink 300 with atmospheric oxygen it can be provided that the application of the ink 300 onto the substrate 200 is implemented in an inert gas atmosphere such as nitrogen or argon.

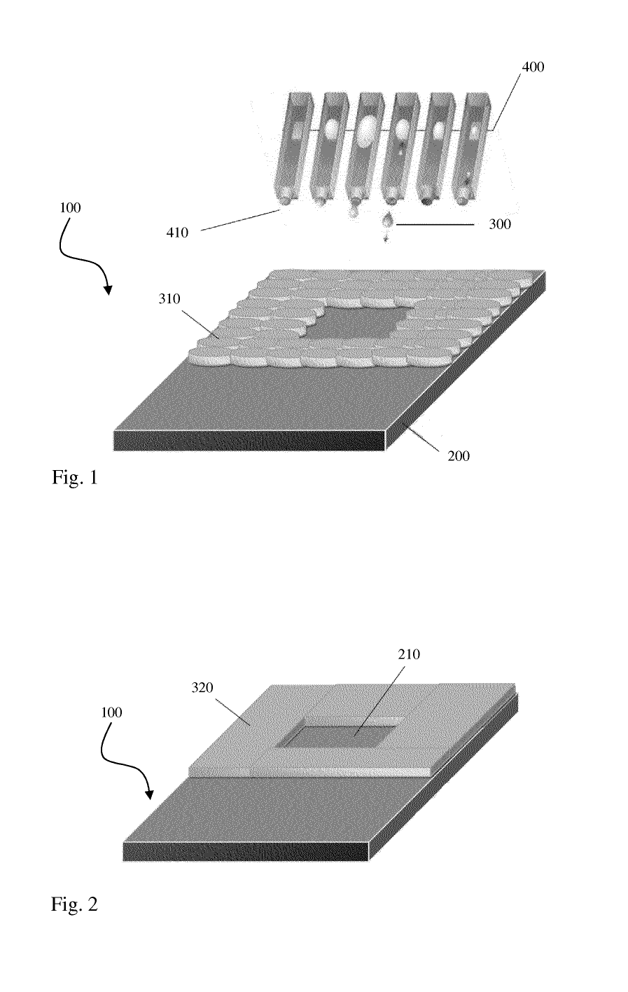

FIG. 2 schematically shows a printing plate 100 produced according to the invention. The applied ink after fixing or curing forms regions 320 on a substrate 200 which have a surface tension of ≦30 mN/m, while the regions 210 not covered with ink have a surface tension of ≧35 mN/m. In the subsequent printing process the regions 210 carry printing ink while the regions 320 repel printing ink. The fixing of the ink 300 can be implemented, for example, thermally or with UV radiation. Depending on the ink 300 used it may also be provided that the ink is fixed or cured by air drying.

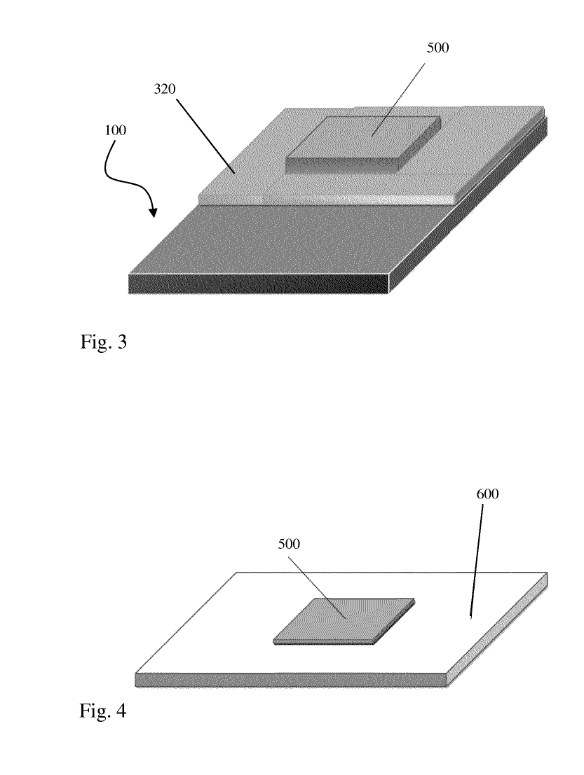

FIG. 3 shows a schematic representation of a printing plate 100 onto which printing ink has been applied. The printing ink is received by the printing plate in the region 500, while the region 320 which is covered with fixed or cured ink, repels the printing ink. In the subsequent offset printing process the printing ink-carrying regions are transferred to the rubber blanket cylinder of the printing machine which then transfers the printed image onto the medium to be printed.

FIG. 4 shows schematically a medium 600 printed by use of a printing plate produced by the method according to the invention. The printing ink-carrying region 500, as described with respect to FIG. 3, has first been transferred from the printing plate onto a rubber cylinder and then onto the medium to be printed.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

1. A method for producing a printing plate for waterless offset printing, comprising:
providing a substrate;
applying an ink onto the substrate by means of an ink jet technique;
fixing the applied ink on the carrier plate;
wherein
the substrate has a surface tension of ≧35 mN/m, preferably ≧38 mN/m and the ink in the fixed state on the substrate has a surface tension of ≦30 mN/m, preferably ≦25 mN/m, and the ink is applied in the regions of the substrate, which in offset printing should not carry any printing ink.

2. The method according to claim 1, wherein at least the surface of the substrate is made of a material selected from the group consisting of aluminum, aluminum alloys, steel, polycarbonate, polyester, and polyolefin.

3. The method according to claim 1, wherein the substrate prior to the application of the ink is pretreated in order to modify the surface roughness.

4. The method according to claim 3, wherein the substrate has an average surface roughness Rₐ of less than 1.

5. The method according to claim 3, wherein the substrate is pretreated by means of pickling, etching, corona treatment or plasma treatment.

6. The method according to claim 1, wherein the ink is fixed by means of UV radiation and/or thermal radiation after the application onto the substrate.

7. The method according to claim 1, wherein said ink is a silicone, in particular a poly(dimethylsiloxane), a polyisoprene, in particular a poly-2-methyl-1,3-butadiene, an acrylate, a silicone oil, a fluorine tenside, a fluorine plastic, a bisacylphosphine oxide, a benzophenone, a perfluoroalkoxylalkane, a perfluorooctane sulfonate, a triphenylmethane, (4-(4,4′-bis(di-methylamino-phenyl) benzhydryliden)cyclohexa-2,5-dien-1-ylidene)-dimethyl-ammonium chloride, a N-methyl-2-pyrrolidone, a short-chained hydrocarbon and/or toluene.

8. The methodMethod according to claim 1, wherein the application of said ink onto the substrate is carried in an inert gas atmosphere.

9. The method according to claim 8, wherein the application of said ink onto the substrate is carried in an atmosphere having an oxygen content of ≦5 vol-%.

10. The method according to claim 8, wherein the application of said ink onto the substrate is carried out in an atmosphere having a moisture content of ≦1 vol-%.

11. The method according to claim 8, wherein a moisture and/or oxygen contact of the substrate between the setting of the surface roughness and the application of the ink is avoided.

12. The method according to claim 1, wherein the ink is applied onto the substrate with a dot density of ≧1200 dpi, preferably ≧2400 dpi.

13. The method according to claim 1, wherein a coloring agent is added to the ink.

14. A printing plate produced by a method according to claim 1.
